(19) United States
(12) Patent Application Publication
(10) Pub. No.: US 2014/0230667 A1
(43) Pub. Date: Aug. 21, 2014

(54) EGG YOLK SEPARATOR

(71) Applicant: Frank Keraga, Selden, NY (US)

(72) Inventor: Frank Keraga, Selden, NY (US)

(21) Appl. No.: 13/866,688

(22) Filed: Apr. 19, 2013

Related U.S. Application Data
(60) Provisional application No. 61/767,581, filed on Feb. 21, 2013.

(51) Int. Cl. A47J 43/14

(52) U.S. Cl. CPC A47J 43/14
USPC 99/497

(57) ABSTRACT

The device may include an egg yolk removing device that has a top portion, a middle portion, and a bottom portion. The top portion may include a bellow, the middle portion may include a main tube, and the bottom portion may include a suction tube. A user may compress the bellow and place the suction tube over an egg yolk. The user may then release the bellow and the yolk may be pushed into the main tube.

### BACKGROUND OF THE INVENTION

The present invention relates to an egg yolk separator and, more particularly, to an egg yolk separator utilizing a bellow system.

Eggs are commonly prepared for breakfast or may be used for a baking recipe. Eggs contain whites and yolks. The yolks of the eggs may contain a large amount of cholesterol. For health reasons or for cooking recipes, it may be desired to separate an egg yolk from the egg white. Currently, it is very difficult to separate the egg yolk from the egg white. A spoon may be used, but this procedure may be very messy and difficult to perform. There are some devices specifically used for separating a yolk from egg whites but they tend to be messy, slow, and require two hands to utilize.

As can be seen, there is a need for an easy to use egg yolk separator.

### SUMMARY OF THE INVENTION

In one aspect of the present invention, an egg yolk separating device comprises: a bellow comprising a closed top end and an open bottom end; a main tube comprising an open top end and an open bottom end, wherein the open bottom end of the bellow is connected to the open top end of the main tube; and a suction tube extending from the main tube having an open end comprising a smaller circumference than the main tube.

These and other features, aspects and advantages of the present invention will become better understood with reference to the following drawings, description and claims.

### BRIEF DESCRIPTION OF THE DRAWINGS

FIG. 1 is a perspective view of the present invention shown in a pre-yolk-suction configuration;

FIG. 2 is a perspective view of the present invention shown in a yolk suction configuration;

FIG. 3 is a perspective view of the present invention shown in a yolk ejection configuration;

FIG. 4 is a perspective view of the invention shown with the billow of FIG. 1 in a non-compressed configuration;

FIG. 5 is a perspective view of the invention shown with the billow of FIG. 1 in a compressed configuration;

FIG. 6 is a bottom perspective view of the present invention;

FIG. 7 is a section detail view of the present invention along line 7-7 in FIG. 2; and

FIG. 8 is a section detail view of the present invention along line 8-8 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an egg yolk removing device. The device may include a top portion, a middle portion, and a bottom portion. The top portion may include a bellow, the middle portion may include a main tube, and the bottom portion may include a suction tube. A user may compress the bellow and place the suction tube over an egg yolk. The user may then release the bellow and the yolk may be pushed into the main tube.

The present invention may include a device that separates egg yolk from egg whites by vacuum. The present invention separates the egg yolk from the egg whites in a speedy manner, the device is easy to use, there is little to no mess, and the yolks generally do not break. Further, the present invention may be used with one hand, leaving the other hand to control other items. The yolk of the egg may be pushed into a tube, where the yolk may be held until expelled into a container.

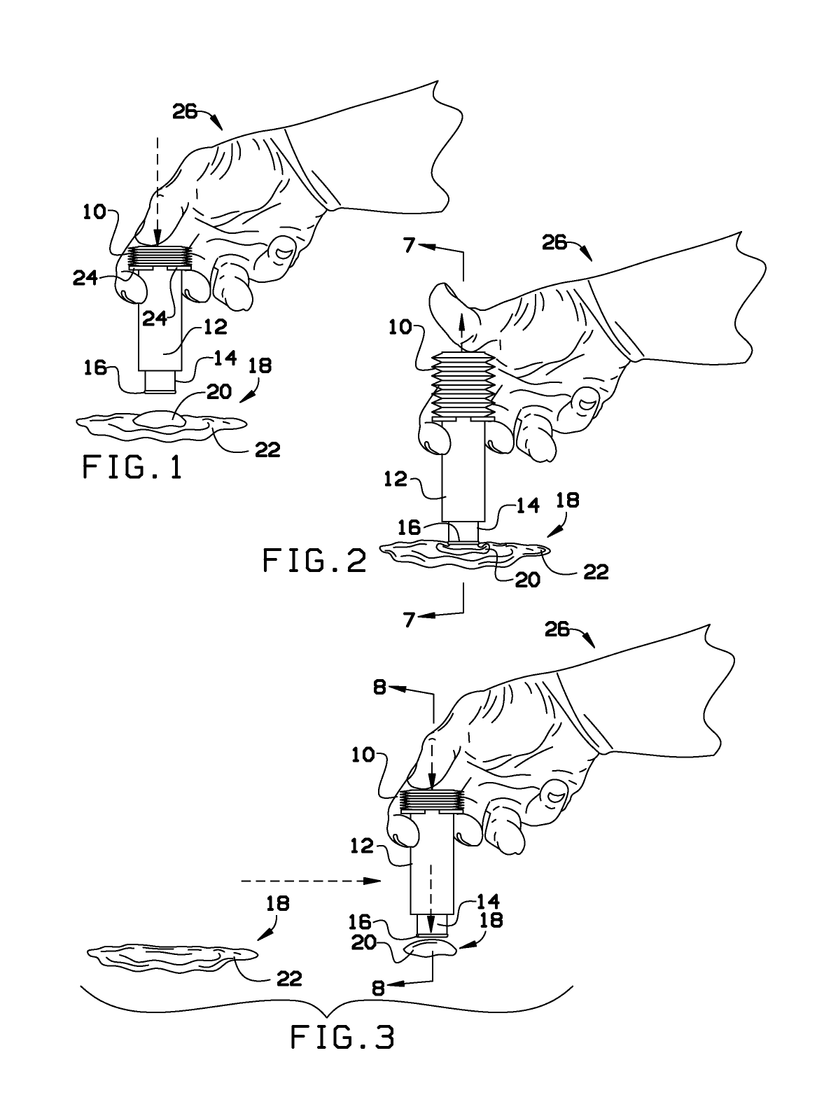

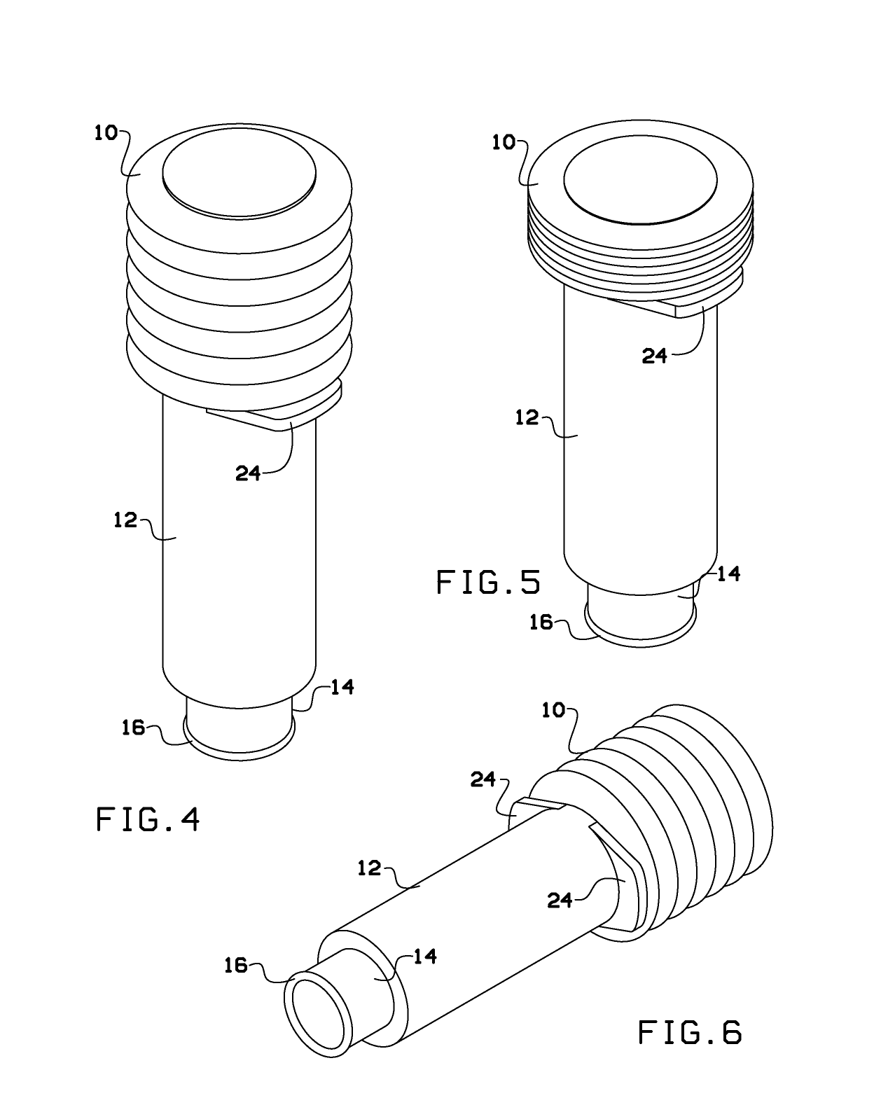

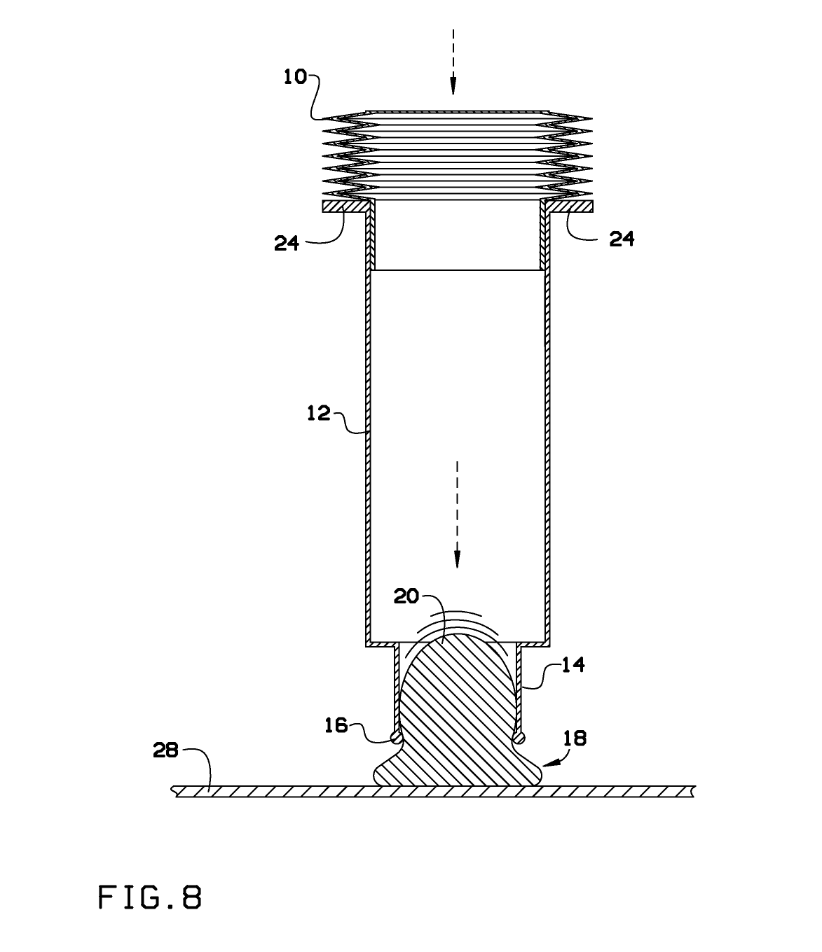

Referring now to FIGS. 1 through 8, the device may include a top portion, a middle portion, and a bottom portion. The top portion may include a bellow 10, the middle portion may include a main tube 12, and the bottom portion may include a suction tube 14. In certain embodiments, the bellow 10 may include an open end and a closed end. The main tube 12 may include an open top end and an open bottom end.

The bellow 10 may be compressible and may push air out of the main tube 12 when compressed. In certain embodiments, the bellow 10 may include a thumb pad on the closed end. A user may thereby place their thumb and push the bellow 10 downwards to compress the below 10.

In certain embodiments, a finger stop 24 may oriented between the bellow 10 and the tube 12. For example, the rim of the top open end of the main tube 12 may include the finger stop 24. The finger stop 24 may have a larger width than the width of the main tube 12. For example, the finger stop 24 may be a solid ridge that has about the same width as the bellow 10. The finger stop 24 may allow a user to securely press down on the bellow 10.

The suction tube 14 may be oriented at the bottom end of the main tube 12. The suction tube 14 may be where the yoke 20 enters. The suction tube 14 may include an edge ring 16 at the end. The edge ring 16 may be used for control so that all of the yolk 20 is removed from the egg white 22. The edge ring 16 may be a ridge that surrounds the circumference of the suction tube 14.

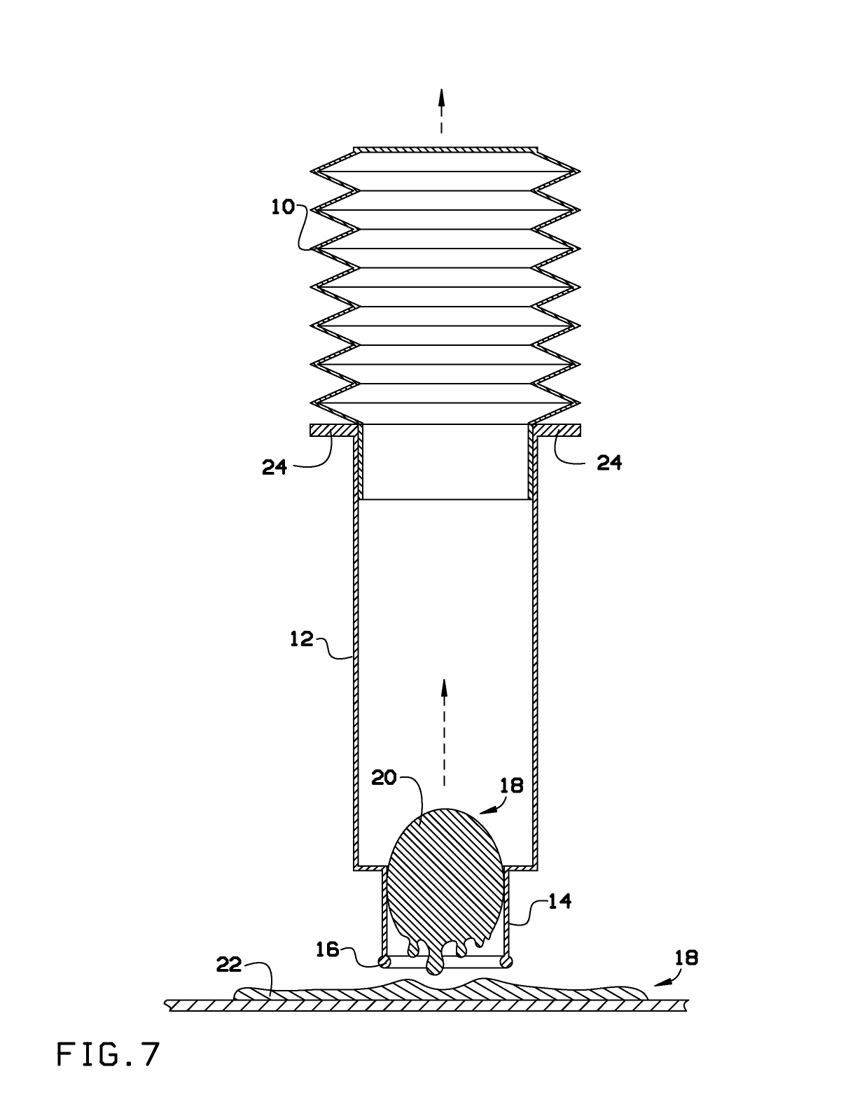

In certain embodiments, the bellow 10 and the main tube 12 may be one connected piece. However, in other embodiments, the bellow 10 and the main tube 12 may be separable. In such embodiments, the bellow 10 may have a tube open end that has a similar circumference to the main tube 12, as illustrated in FIG. 7. Thereby, the end of the bellow 10 may be compressed and fit snuggly within the main tube 12 so that the bellow 10 may be attached and detached from the main tube 12 with ease. The bellow 10 and the main tube 12 may be separated for cleaning purposes.

In certain embodiments, the main tube 12 may be about six inches in length. The main tube 12 may have a width between about one and one-half inches and about two inches. The suction tube 14 may be about seven-eighths of an inch wide and may have a length of about a half of an inch up to about one and a half inches.

To use the invention, the bellow 10 may be pushed downwards to release the air within the main tube 12. A user 26 may then place the suction tube 14 end against the egg yolk 20. The user 26 may than release the bellow 10 to allow the bellow 10 to expand. The egg yolk 20 may then be pushed up through the suction tube 14 and into the main tube 12. The egg yolk 20 is thereby separated from the egg white 22. The user 26 may then eject the egg yolk 20 from the suction tube 14. In certain embodiments, the user 26 may also separate the bellow 10 from the main tube 12 to release the egg yolk 20 and/or to clean the device.

The tube 12 may be made of various materials including metals, such as stainless and copper, or polymers such as plastic and nylon which may be molded. The bellow 10 may be molded from a compressible polymer such as rubber, plastic, latex, or other synthetics. In certain embodiments, the shape of the device may be changed. For example, it may be made to look like an animal, a fried egg, a house and the like.

It should be understood, of course, that the foregoing relates to exemplary embodiments of the invention and that modifications may be made without departing from the spirit and scope of the invention as set forth in the following claims.

What is claimed is:

1. An egg yolk separating device comprising:
a bellow comprising a closed top end and an open bottom end;
a main tube comprising an open top end and an open bottom end, wherein the open bottom end of the bellow is connected to the open top end of the main tube; and
a suction tube extending from the main tube having an open end comprising a smaller circumference than the main tube.

2. The device of claim 1, further comprising a rim ring protruding from the circumference of open end of the suction tube.

3. The device of claim 1, wherein the closed top end of the bellow comprises a thumb pad.

4. The device of claim 1, further comprising finger stop attached between the bellow and the main tube, wherein the finger stop has a greater width than the main tube.

5. The device of claim 1, wherein the open bottom end of the bellow comprises a tube that has a similar circumference as the main tube, and the bellow attaches to the main tube by insertion of the tube of the bellow into the open top end of the main tube.
